(19) United States
(12) Patent Application Publication
(10) Pub. No.: US 2022/0162507 A1
(43) Pub. Date: May 26, 2022

(54) ELECTROCHEMICAL SEPARATION AND RECOVERY PROCESS

(71) Applicant: John Taylor, Amersham (GB)

(72) Inventor: John Taylor, Amersham (GB)

(21) Appl. No.: 17/669,741

(22) Filed: Feb. 11, 2022

Related U.S. Application Data
(63) Continuation-in-part of application No. 16/959,945, filed on Jul. 2, 2020, now Pat. No. 11,248,177.

(30) Foreign Application Priority Data
Feb. 12, 2018 (GB) 1802236.8

(51) Int. Cl. C10G 32/02; C10G 31/06; C10G 53/14; B01D 3/10

(52) U.S. Cl. CPC C10G 32/02; C10G 31/06; C10G 2300/1003; B01D 3/10; C10G 2300/202; C10G 53/14

(57) ABSTRACT

We disclose a process for purification of mixed hydrocarbons, suitable for a wide range of contexts such as separating and recovering mixed polymer materials, refining used oils and fuels, recovery of hydrocarbons from used tyres, recovery of hydrocarbons from thermoplastics etc, to yield clean hydrocarbon distillates suitable for use as recycled feedstocks in chemical industries or as low sulphur fuels for motive use, as well as the treatment of crude oils, shale oils, and the tailings remaining after fractionation and like processes. The method comprises the steps of heating the hydrocarbon bearing material thereby to release a gas phase, contacting the gas with an aqueous persulphate electrolyte within a reaction chamber, and condensing the gas to a liquid or a liquid/gas mixture and removing its aqueous component. It also comprises subjecting the reaction product to an electrical field generated by at least two opposing electrode plates between which the reaction product flows; this electrolytic step regenerates the persulphate electrolyte which can be recirculated within the process. The process is ideally applied in an environment at lower than atmospheric pressure, such as less than 14000 Pa. A wide range of mixed materials and hydrocarbons can be separated and treated in this way. Used hydrocarbons such as mixed plastic packaging waste, industrial polymers, pyrolysis oils etc, are typical examples, but there are a wide range of other materials having a hydrocarbon content. One such prime example is a mix of used rubber (such as end-of-life tyres) and used oils (such as engine oils, waste marine oils) etc, which can be pyrolysed together to yield a hydrocarbon liquid which can be treated as above to provide a carbon black residue that has extensive industrial uses.

### CROSS-REFERENCE TO RELATED APPLICATION

This Application is a continuation-in-part of U.S. patent application Ser. No. 16/959,945, filed Jul. 2, 2020, which is a Section 371 National Stage Application of International Application No. PCT/GB2019/050176, filed Jan. 23, 2019, and published as WO 2019/155183 A1 on Aug. 15, 2019, in English, which claims priority to GB patent application Serial No. 1802236.8, filed Feb. 12, 2018, the contents of which are hereby incorporated by reference in their entirety.

### FIELD OF THE INVENTION

The present invention relates to a process for the separation, recovery, processing and recycling of recovered mixed materials containing hydrocarbons and/or solid materials. It aims to provide a low energy process applicable in particular to materials having a reprocessing value (including rubber, plastics, oil, paper and metal materials) in reprocessing or as new materials or feedstocks for industrial manufacture of new products.

### BACKGROUND ART

Whilst there are environmental concerns over the finite nature of virgin materials, there is a strong and rapidly growing realisation that to safeguard our environment we must consider how we use and recover valuable resources, and such issues are now being considered as part of many industrial manufacturing processes. Resources include natural and synthetic products and the energy required to make them, but also how end of life products can be recovered, recycled or disposed of without causing environmental harm.

Substances that cannot be recycled and require landfill or incineration are examples of poor environmental stewardship by causing potential air pollution or long term ground/water leaching emissions which reflect poorly on the manufacturer of the original product.

A particularly relevant example is where packaging is designed to allow materials to be more easily used or dispensed (such as cartridges for glues and sealants), metallised packaging for liquids (drinks, creams etc.) or loose food items (peas etc.).

Once the package contents have been used, none of the pack types mentioned can be commercially or hygienically refilled or reused, and are therefore disposed of as waste. Even where well organised attempts have been made to develop commercial collection and recycling infrastructure, there is a requirement to separate the packs into similar types, purge any internal product residues and clean the remaining packaging before further recycling/reprocessing can take place. Without automation assistance in this area of recycling, the described process is commercially unsustainable at present.

In addition, advances in manufacturing technologies are now producing complex combinations of traditional materials such as paper laminates coated or combined with metals or plastics that provide strong, light products that are impervious to light/heat/etc. These material combinations cannot be easily separated by traditional physical methods, which can lead to them being classified as solid waste and resulting in valuable materials being consigned to landfill or incineration, both of which are detrimental and likely to cause significant water, ground and CO2 emissions to air.

In order to recover advanced materials, advanced recovery techniques are required, using specialised technology which is not generally available to waste industries. To meet this growing challenge, an advanced extraction and processing technology has been developed. The technology is based upon an existing process which has been further developed to enable fine separation of combined, but dissimilar materials.

### SUMMARY OF THE INVENTION

The present invention permits the majority of hydrocarbon-bearing materials to be recovered and processed, to yield new materials that may be used as feedstocks in new chemical production processes. The described process can be operated with a low energy requirement, a low carbon footprint, low operating costs, and substantially no harmful emissions. For convenience, the process is henceforth referred to herein as the ESAR process (Electrochemical Separation and Recovery process).

In order to replace virgin materials, feedstocks must be equivalent to the materials they are to replace and where mixed waste polymers are reprocessed, there is a positive danger that contaminants (such as halogens from PVC and/or other heteroatoms) might be included within the materials being reprocessed, which could cause the feedstock to be rejected. Such rejection is likely to require additional processing with associated energy/CO₂ generation or create a disposal problem.

The present invention therefore seeks to provide a method for separating, processing and recovering natural and synthetic hydrocarbons from mixed materials to provide clean new solid and liquid chemical feedstocks.

It is well known that many monomers and polymers have widely different chemical construction and physical characteristics. An obvious example of this is rubber vulcanisation where layers of different rubber, metal and synthetic reinforcements are bonded together by the addition of bonding chemicals in a heat process.

Similarly in a packaging environment, layers of paper or card may be bonded together with a chemical adhesive, have one external surface layer overlaid with thin polymer coatings, and yet another surface may have a thin metallic coating as may be produced by vapour deposition processes. The combined materials may be further bonded together by heat, or pressure, or both processes combined.

It will be readily understood that each of the materials comprising bonded packaging will have dissimilar chemical/ physical properties and where separation of materials is required, each material will have a particular vapour pressure (“VP”) range.

It has been found by experiment that it is possible to separate the various layers and chemical constituents by application of heat and pressure in a certain sequence.

In its first aspect, the present invention provides a method whereby mixed materials (“MMs”) are contained within a vessel and subjected to heat and vacuum pressure (which thus define a first process profile) so that lower boiling point materials reach a first VP.

Gas released at this VP is exhausted, preferably to a first stage reaction assembly, where it is contacted with an aqueous electrolyte to cause a chemical reaction and condense the gas to a liquid or a liquid/gas mixture. This can be passed to a reaction and/or collection column where any uncondensed gas from the first stage reaction vessel is further reacted with an electrolyte spray and thereafter its aqueous component is removed.

The mechanical process is so constructed that MMs from the first process profile are then subjected to a second process profile, ideally in a second vessel provided with a separate heat and vacuum control to enable imposition of a temperature and/or a vacuum pressure which is elevated relative to the first process profile, i.e. increased heat with maintained vacuum pressure, or maintained heat with increased vacuum pressure, or increased heat with increased vacuum pressure. This results in a second proportion of the feedstock reaching a VP. The gas released at that VP can be exhausted to a second stage reaction assembly and be contacted with an aqueous electrolyte, condensing the gas to a liquid or a liquid/gas mixture. This can be passed to a secondary reaction and collection column where any uncondensed gas from the second stage reaction vessel is further reacted with an electrolyte spray, thereafter removing its aqueous component.

Mixed material from the second process profile can be subjected to a third process profile, ideally in a third vessel, which has a separate heat and vacuum control to enable imposition of a temperature and/or a vacuum pressure which is elevated relative to the second process profile, which can allow a yet further proportion of the MMs to reach a VP. Gas released at this VP can be exhausted directly to a third stage reaction assembly, where it is contacted with an aqueous electrolyte to cause a chemical reaction and then condenses the gas to a liquid or a liquid/gas mixture which then passes to a secondary reaction and collection column where uncondensed gas from the third stage reaction vessel is further reacted with an electrolyte spray, thereafter its aqueous component is removed.

It will be apparent that additional process profiles can be added to the process invention until a vapour pressure is achieved which is sufficient to ensure that all hydrocarbons within a known or selected VP range have been extracted from the mixed material.

In general, once hydrocarbons have been removed from the materials, there will remain a solid carbon residue which may constitute raw carbon black. However, where the materials to be processed contain valuable residues other than hydrocarbons, (for example paper/card or metals), it is possible to control the process profile by temperature and/or pressure so that the chemicals bonding the separate materials together are sufficiently decomposed to allow the materials to separate by mechanical agitation or other simple means so that the paper/metals etc. can be recovered before potentially being damaged by further process profiles.

To ensure that heteroatoms in feedstock gases are reduced or removed to levels acceptable for commercial reprocessing, the heteroatoms are subjected to continuous radical reaction by contact with the electrolyte whereby heteroatoms lose electrons and become positively charged to their highest state of oxidation and dissolve into the aqueous electrolyte.

Separation of an aqueous phase from a hydrocarbon phase is relatively straightforward and will then take with it the reacted contaminants leaving behind a hydrocarbon liquid. Thus, the separation step removes the aqueous component and recovers the hydrocarbon condensate as a distillate with a high proportion of heteroatoms and contaminants reduced or removed to levels that make it acceptable as a feedstock for commercial processing.

Contact between the gas and the aqueous persulphate electrolyte can be by spraying the electrolyte into the gas or a stream of the gas, or by bubbling the gas through the electrolyte in solution, or by other means.

Separation can be by way of a mechanical means such as are known in the art. Following separation, the hydrocarbon liquid is preferably admixed with a polar solvent so that non sulphated polar contaminants in the hydrocarbon phase are attracted to and dissolved into the solvent and then passed to a solvent recovery process such as a vacuum distillation step.

The aqueous electrolyte can be held in a reservoir prior to being contacted with the gas phase hydrocarbon. In this case, we prefer that the reservoir is maintained at a temperature of less than about 50 degrees Celsius, ideally less than 15 degrees Celsius.

The hydrocarbon-bearing MMs are preferably supplied in a continuous stream, to which the method is then applied.

In its second aspect, the present invention provides a method of treating liquid hydrocarbons, comprising reacting the hydrocarbon with an electrolyte thereby to oxidise heteroatoms in the hydrocarbon and subjecting the reaction product to an electrical field generated by at least two opposing electrode plates between which the reaction product flows.

The electrode plates are ideally substantially parallel, spaced apart by a distance between each electrode surface of between 1 and 5 millimetres, and carry an electrical current density between 2 and 3 amps per square centimetre of electrode surface area. A DC voltage in the range of 80-100 volts is usually sufficient for this purpose.

This electrolytic step regenerates the electrolyte within the reaction product. The aqueous phase containing it can be separated and, ideally, passed through an ion exchange or reverse osmosis device or ceramic membrane to remove oxidised heteroatoms therein, thus yielding substantially uncontaminated electrolyte that can be recirculated within the process.

The above methods may be applied in an environment at lower than atmospheric pressure. This assists by reducing the effective vapour pressure of the hydrocarbon content of the materials being processed, allowing heavier fractions to be processed whilst remaining at manageable temperatures. A pressure of 14,000 Pa or lower is preferred.

A wide range of mixed materials containing hydrocarbons can be treated in this way. Mixed plastic wastes are prime examples where thermosetting and thermoplastic types have widely different processing requirements.

### BRIEF DESCRIPTION OF THE DRAWINGS

An embodiment of the present invention will now be described by way of example, with reference to the accompanying figures, in which:

FIG. 1 is a schematic general layout illustrating the process of the invention;

FIG. 2 shows an alternative form of vessel 4; and

FIG. 3 is a diagrammatic sectional view of the reaction chamber 11.

### DETAILED DESCRIPTION OF THE EMBODIMENTS

Within this application, the phrase ‘contaminant species’ is used to mean heteroatoms, chemical compounds and any physical materials that are specifically excluded by species, mass or volume, from any technical specification pertaining to an energy or liquid chemical product deriving from this embodiment. Examples of contaminants include (but are not limited to) Sulphur, halogens, Nitrogen, solid and dissolved metals, chars.

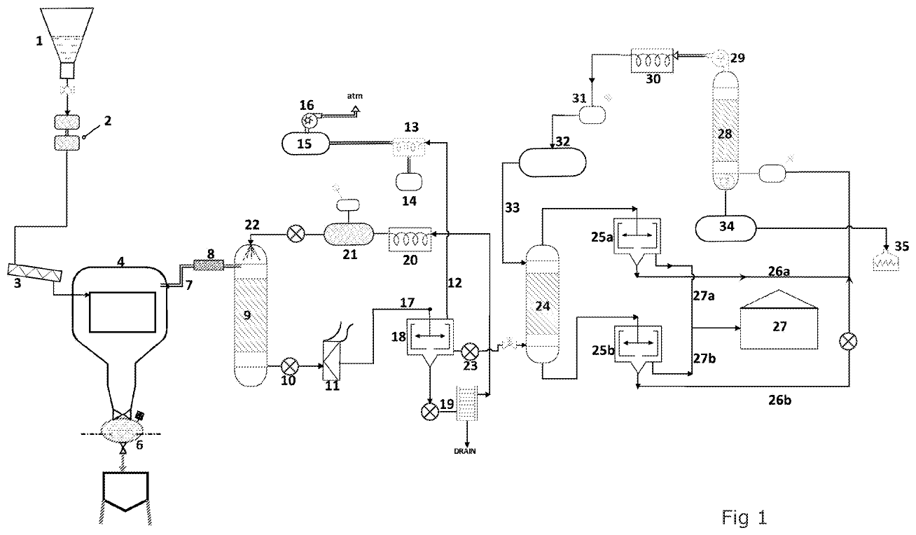

FIG. 1 depicts a scheme comprising vessels, pumps, pipes, heat sources, coolers, separators et al in an illustrative process sequence. It will be readily understood by those familiar with process engineering that variations in process layout are possible without changing the intent of the embodiment. In particular, variations may be made as necessary or desirable to accommodate different starting materials and process aims. However, FIG. 1 illustrates one process route that is operable and embodies the present invention.

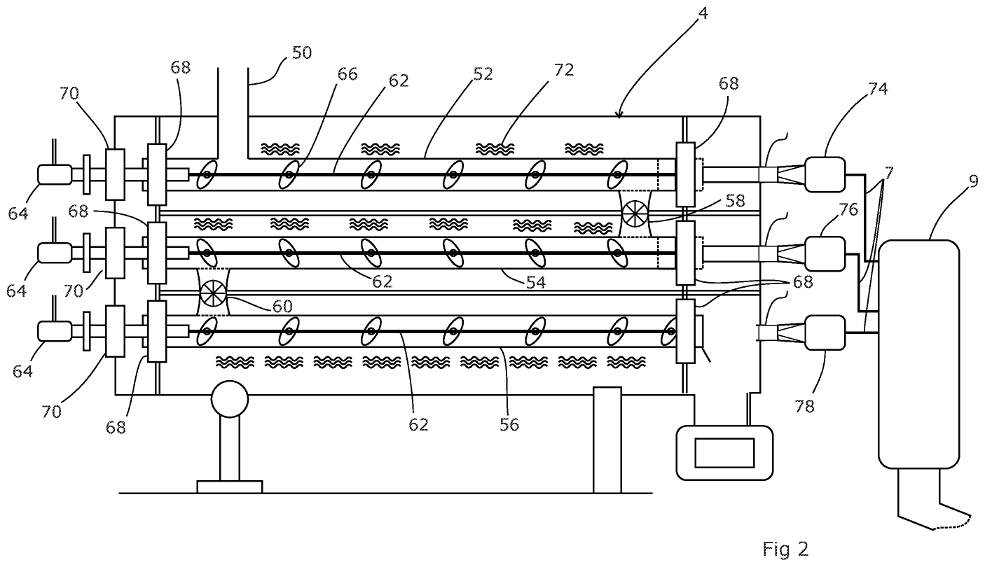

Bulk supplies of solid or liquid materials that are to be treated (or a mixed combination of those materials) are provided to a reservoir 1. This may be insulated and heated if necessary, to assist viscous materials to exist in a form that allows them to pass by gravity or mechanical means. Material in the reservoir 1 passes to an airlock device 2 which is intended to prevent direct connection to atmosphere between the reservoir and the ESAR chamber illustrated schematically at 4 (shown in more detail in FIG. 2), which might otherwise allow air/oxygen to enter the process and produce conditions whereby combustion could take place. Materials pass from the airlock to a mechanical feed device 3, which in the case of a liquid would be a pump, or in the case of a solid (or a mixture of solids and liquid) may be a pump, or mechanically driven auger, or other such mechanical device. The feed devices are a means of causing the mixed material to be continuously introduced into the first ESAR vessel 52 within the chamber 4 via conduit 50 (FIG. 2) at a controlled rate.

Where solid material is to be treated, it is desirable to prepare individual pieces to a size that allows the largest possible surface area to absorb the heat available in each process profile, subject to limitations imposed by the size of pipes, mechanical feed devices and the vessel dimensions. Irregular shaped pieces of material are most advantageous and it has been found that pieces having a length to width ratio of between 10:1 and 20:1 are more rapidly pyrolysed.

Where liquid material is to be treated, that material should be able to achieve a viscosity, by heating or otherwise, that will allow it to flow or to be pumped into the ESAR vessel 4 at a constant rate, consistent with the ability of the heating source within the vessel 4 to match or exceed the enthalpy of vapourisation of the liquid.

Within the ESAR process there is a series of vessels shown in FIG. 2, in the form of hollow cylinders, tubes, troughs or other mechanical devices 52, 54, 56 able to support and substantially enclose the material to be pyrolysed whilst that material is subjected to the heat and reduced pressure of each process profile. Apart from any vacuum/airlock connections provided between the vessels, each vessel is self-contained and individually heat and vacuum controlled.

Each ESAR vessel 52, 54, 56 may be heated by any available heat energy source 72 that will provide a sufficient and continuous level of heat required to maintain the enthalpy of vapourisation within the process. For example, heating may be provided in the form of one or more hollow tubes wound around the external periphery of each ESAR vessel 52, 54, 56. The tubes may contain electrical elements, steam, hot gas from combustion or any other heat source that is able to provide radiant or convective heat directly to the pyrolysis material or through the wall of a tube or pipe through which the pyrolysis material passes. The method of heating may be organised to achieve efficiency or in accordance with preference, design, safety or local regulation. It will be evident to the skilled reader that many alternative heating arrangements might be employed without changing the intent of the embodiment.

As the primary mixed material is heated under first process profile conditions in the first ESAR vessel 52 the material will become thermally degraded to the extent that some component gases of the material are released within the first ESAR vessel and pass into a directly connected first reaction chamber 74 to be reacted with a first electrolyte and thereafter into a secondary reaction/collection column 9.

Mixed material that has not achieved a vapour pressure within the first process profile passes along the first ESAR vessel 52 until it reaches a part of the vessel that is directly connected to the second ESAR vessel 54 via an air (vacuum) lock 58 so that material can be transferred by mechanical means from the first vessel 52 into the second vessel 54 to become secondary mixed material. This secondary material is subjected to second process profile conditions so that it will become further thermally degraded, to the extent that some component gases of the material are released into the ESAR vessel. The second process profile conditions essentially drive the vapourisation process further by imposing at least one of a higher temperature and a lower pressure (i.e. a higher vacuum pressure). The released gases pass to their own directly coupled reaction chamber 76 to be reacted with electrolyte and thereafter into the secondary reaction/collection vessel 9.

Mixed material that has not achieved a vapour pressure within the secondary process profile passes along the second ESAR vessel 54 until it reaches a part of the vessel that is directly connected to the third ESAR vessel 56 via a further air or vacuum lock so that mixed material transfers by mechanical means from the second vessel into the third vessel to become tertiary mixed material. This tertiary material is subjected to still higher process profile conditions in terms of temperature and/or vacuum pressure so that it will become thermally (or otherwise) degraded to the extent that some or all remaining component gases of the material are released into the ESAR vessel. The released gases pass to their directly coupled reaction chamber 78 to be reacted with electrolyte and thereafter into the secondary reaction/collection column 9.

The arrangement of ESAR vessels may take a multitude of forms. FIG. 2 illustrates an example layout although one practised in the art will understand that there are many potential variations to the method illustrated, such as a moving mesh belt arranged in one or multiple layers, one or multiple fixed or moveable inclined tubes or any other mechanical means of permitting material to travel by gravity or mechanical motion through the heated zone of the ESAR vessels. Such alternative physical and mechanical arrangements are possible without changing the intent of the embodiment.

In the present embodiment, ESAR vessels 52, 54, 56 are mounted into vessel 4. A shaft 62 is mounted on bearings 68 and seals 70 at each end of each vessel and also passes through each ESAR vessel. The shaft 62 may be mechanically driven at one end by an electric motor 64, for example, and may be in the form of an auger 66 or such other mechanical means to positively move mixed materials through the vessel. The mechanical drive may have a variable speed capability to cause the mixed materials to pass more slowly or quickly through the ESAR vessel to provide additional process profile adjustment. It will be apparent to a skilled reader that other mechanical devices may equally be provided to cause the materials to pass through the ESAR vessel.

The externally mounted cylinder shaft bearings and seals may be air, liquid or otherwise cooled, and/or each shaft may have a non-conducting section included in its length to prevent or reduce excess heat being transmitted along the cylinder shaft.

The ESAR vessels may be constructed from (but not limited to) stainless steel, steel mesh, quartz glass, ceramic, or any other material capable of withstanding the temperatures that are likely to be utilised during the ESAR process. In particular, consideration must be given to the material of construction of the vessels or tubes, as the ability to transfer heat from the external heat source to the material to be pyrolysed (heat transfer coefficient) will directly affect the speed and efficiency of the process.

The heat transfer coefficient ‘h’ is the ratio of heat flux ‘q’ (heat flow per unit area) to the difference between the temperature ‘Tₛ ‘of the surface and that of medium to be heated, ‘Tₐ’ and may be stated thus:

$$h = \frac{q}{{T}_{s} - {T}_{a}}$$

It might be considered that materials with a high heat transfer coefficient such as copper or brass would be preferred, but the temperatures used within the pyrolysis process are likely to be above the softening or melting point of such materials which renders them unsuitable for a pyrolysis type process.

Where solid or liquid materials are processed, the char formed during pyrolysis may pass completely through the ESAR process to be ejected from the final ESAR vessel to be collected at the bottom of vessel 4 in a char storage vessel 6.

The char storage vessel is fitted with an airlock device, to allow char to be removed from time to time as required, without allowing air/oxygen to enter vessel 4 which might result in conditions allowing rapid uncontrolled combustion. More than one char storage vessel may be provided to allow alternate vessel emptying. A heat exchanger may be located within the char storage vessel to allow heat recovery from the hot char. Commercial systems are available to meet these requirements. where the heat contained within the char is recovered by a heat exchange device.

A negative atmospheric pressure (i.e. a partial vacuum) is maintained within the process system by vacuum pump 16. Thus, as gases are formed by pyrolysis in ESAR vessels they will naturally create a slightly higher pressure than the negative atmospheric pressure being maintained in the remainder of the process system. As gases are formed, therefore, they are caused to immediately flow to each of the individually coupled reaction chambers 74, 76, 78 and then to the secondary reaction/collection vessels 8, 9 via connector tube 7.

Within vessel 4, a combination of temperature and reduced pressure will result in an atmospheric equivalent temperature (AET). In other words, volatile components in the material being processed in ESAR vessels will be produced at a lower temperature due to the reduction in pressure. The AET is thus the temperature that would be required in order to produce the same effect at normal atmospheric pressure, which will be significantly higher than the actual temperature reached in the ESAR vessels. Thus, lowering the operating pressure by way of the vacuum pump 16 simultaneously encourages the volatile components to leave the ESAR vessels and enter each reaction chamber thereafter to vessels 8 and 9, and allows operation at a lower temperature thereby reducing the energy demand of the process. The AET may also be rapidly increased or decreased by adjusting each of the pressures within the process system (by means of a vacuum regulating devices), which enables the overall effective process temperature to be increased or decreased at a faster rate than can be achieved by increasing or decreasing the heat energy being input to the system.

It has been found that natural variations in materials entering ESAR vessels will cause gas volumes to be generated at varying rates, potentially causing a rapid change in actual pressure within the process system and thus also changing the AET. To maintain the required AET, each system pressure adjustment may be carried out automatically by a pressure sensing device connected to a pressure regulating device so that as varying gas volumes are produced, each system pressure is automatically adjusted to maintain the required AET.

One useful simplification of the above-described system is to operate the vessel 4 at a single uniform pressure, with the process profiles differing in their respective temperatures. This removes the need for airlocks 58, 60 between the successive vessels 52, 54, 56 since they are at the same pressure. Likewise, the reaction chambers 74, 76, 78 can be combined, possibly further combined with the vessel 9.

Thus, it will be evident to the skilled reader that it is possible to achieve a wide range of temperatures and thus process profile conditions within ESAR vessels by employing a combination of negative pressures, heat energy inputs and speed at which mixed materials proceed through the process.

It is a feature of this embodiment that the temperature flexibility described above causes some materials (gases, biomass, some oils) to achieve a gas phase at a lower temperature than would otherwise be achieved at atmospheric pressure. This enables some hydrocarbon bearing materials to be processed as described but without heating the materials to a point that might otherwise cause unwanted changes in the physical characteristics of some of the end product. An example of separating combined layers of material is described earlier in this application.

It is a further feature of this embodiment that where ‘torrefaction’ of biomass is required, this can be achieved at a low temperature and pressure. Torrefaction of biomass (e.g. wood or grain) is a mild form of pyrolysis at temperatures typically between 200 and 320° C., intended to change the properties of the biomass to provide a better quality product for subsequent processing into bio-oil, or chemical products or for combustion and gasification applications and to provide a dry product without biological activity such as rotting. Fuller details are provided at https://bit.ly/lsf-3Lpd1yT. In torrefaction, it is desirable to remove moisture, acid gases, oxygen content and non-condensable gases so that the biomass material is concentrated into a dry, compact form that is lighter and cheaper to transport, store and mechanically handle. In that concentrated form, the biomass has a higher calorific value per kilo. Further, where bio-oil is created from biomass, it is reported that excess oxygen within the bio-oil can cause its rapid degradation. It has been found that by processing biomass through the process of the present invention, excess oxygen is removed from the process stream, obviating the need to hydro-treat the bio-oil to remove excess oxygen.

It is a yet a further feature of this embodiment that oil contaminated with Polychlorinated Biphenyls (PCBs) may be pyrolysed to a temperature above its constituent boiling points so that chlorine compounds within the oil will be oxidised to aqueous soluble chlorate during processing within the system. De-chlorinating the oil will render it harmless as it will then be free of PCB contamination. The oil may be further cracked to a light distillate, making it usable as a safe fuel commodity having a commercial value and separately, removing the need for specialist incineration as is normally required for PCB contaminated oil.

It is a yet a further feature of this embodiment that oils having a low viscosity and/or higher boiling range (above 700 degrees C.) and sometimes described as ‘heavy’ oils can be effectively processed in combination with other hydrocarbon bearing materials. These heavy oils are likely to have a low proportion of recoverable volatile, low molecular weight compounds, but by processing the heavy oils in combination with (for example) rubber, the hydrocarbon content of the rubber can be recovered at AET temperatures of 300 to 450 degrees Celsius to leave a char which absorbs the non-boiling heavy oils. The impregnated char so produced, will retain the hydrocarbon content of the heavy oil and (when cooled) it will have a granular form which may be used as a fuel suitable for a solid fuel boiler or used in a gasification boiler to provide heat energy.

It is yet a further feature of this embodiment that oil bearing shale type materials may be directly processed without the need for water or steam pre-heating. The excavated porous solid (or near solid) hydrocarbon bearing material may be loaded into the thermal process (subject to pipework size limitations) as excavated. At the appropriate hydrocarbon boiling point, the hydrocarbon contained within the solid will become a gas and due to the lower pressure within the process, the gas will be drawn out of the porous shale material and will be processed in the same manner as other gases previously described. The hydrocarbon-free shale will be discharged from the thermal process and after heat recovery, may be returned to local ground structures.

Returning to FIG. 1, as described above, gases are contacted and reacted with electrolyte in each reaction chamber and so that liquids and uncondensed gases pass through pipe 7 to vessel 8 (not shown in FIG. 2) which may be a fixed or removable section designed to act as a mounting point for temperature, flow and gas sampling sensors. Gases and liquids pass from vessel 8 to column 9, which is in the form of a vertical cylinder. The column is similar to a distillation column in that it may be partly packed with chemically inert random packing designed to provide a wide surface area of contact with materials passing through the column. Uncondensed gases are directed into the head of column 9, where they are further contacted with a cooled liquid electrolyte by one or more spray nozzles 22. An alternative would be to bubble the gases through a reservoir of electrolyte. The electrolyte is an aqueous persulphate and contact with the hot hydrocarbon gases activates the electrolyte and causes it to break down into multiple gas components which react with the hydrocarbon gases and with each other. The multiple reactions that take place result in the rapid formation, breakdown and conversion of gases including ozone, hydrogen peroxide and super-oxides with associated multiple electron exchanges between the gases causing highly reactive radical species to be generated. For the persulphate, we prefer peroxydisulphuric acid (PDS) (H₂S₂O₈). It is also possible to use peroxymonosulphuric acid (H₂SO₅), but this is less preferred as it is somewhat volatile (i.e. explosive) and therefore PDS usually needs to be made in situ as and when needed. Other persulphate compounds are also effective, such as the salts derived from the corresponding acids—in particular Na₂S₂O₈ and K₂S₂O₈.

We have found that the continuous flow of hot hydrocarbon gases will react with a continuous flow of fresh electrolyte to provide the conditions necessary for a chain reaction to be established, whereby multiple radical species such as hydroxyl and sulphate radicals are continuously formed. These radical species have a high oxidation potential of 2.8 (V) and 2.6 (V) respectively. By reaction with the radicals so produced, heteroatoms within the gases preferentially have their molecular structure altered in successive electron transfer reactions to achieve their highest state of oxidation so that they are susceptible to dissolving into the electrolyte.

The volume of electrolyte contacting the hot gases is controlled to ensure that all selected gases are condensed in the reaction assemblies or in the secondary reaction/vessel. The shape and volume of the assemblies and column is designed so that a continuous volume of electrolyte, uncondensed gases and hydrocarbon condensate is maintained through the vessels to ensure thorough mixing. Gravity and negative system pressure ensure that the hydrocarbon condensate, electrolyte and non-condensed gases gather at the bottom of the column and are then pumped (10) through a continuous electrical field in vessel 11, to be described below.

It will be readily envisaged by those familiar with process systems that variations in layout of the reaction assemblies and column 9 and the associated pipework are possible. For example, liquids and gases may be introduced to the bottom of vessel 9 and allowed to travel in a counter current flow to the electrolyte.

As gas, hydrocarbon condensate and electrolyte pass through reaction assemblies and column 9, temperatures are controlled to be above the condensation temperature of light gases in the Naphthalene range so that those Naphtha gases are not condensed but remain as gases as they pass through column 9 and through the remainder of the process system until condensed in a subsequent part of the process.

As the electrolyte/hydrocarbon condensate/gas mixture enters the reaction chamber 11, it passes between two or more electrode plates. These are connected to a direct current electrical supply, which is set to automatically produce and maintain an electromotive force (EMF) sufficient to cause a combined electrosynthesis/electrolysis reaction to occur within the aqueous electrolyte from column 9. The acid or alkali reaction creates a persulphate and in so doing, also forms oxygen and hydrogen gases. The creation of multiple compounds and gases within the electrochemical cell 11, causes the generation of hydroxyl, sulphate and other radicals which cause a further oxidising reaction on heteroatoms remaining within the hydrocarbon condensate as described in the first stage oxidation reaction, thus causing remaining heteroatoms to substantially or entirely dissolve in the aqueous electrolyte.

Further, dissolved metals that have not been oxidised within the reaction vessel become polarised within the second stage oxidation reaction which allows their extraction by polar solvent in a later process stage.

After the uncondensed gases exit the reaction chamber 11, they pass via pipe 17 to a separator 18. The gas components exit the separator 18 via pipe 12 and are delivered to a cold trap chiller 13 to be condensed, collected, and stored in vessel 14 at a sufficient low temperature to maintain them in a liquid state. The condensed Naptha fluid will be virtually free of heteroatoms suitable for commercial use, or it may pass through an airlock directly to a thermal oxidiser (or other safe combustion device) to be burned to provide process heat.

Non-condensable gases pass through the chiller 13 and are collected in reservoir 15, from where they are extracted through an air lock and directed to a combustion process such as a thermal oxidiser or the like, to be incinerated to provide process heat or compressed and chilled to a liquid state for other commercial uses.

The electrolyte and hydrocarbon condensate separately exit the separator 18, and the electrolyte is passed through a reverse osmosis, ion exchange mechanism or ceramic vacuum membrane 19 to remove oxidised heteroatoms. The cleaned electrolyte is then recycled within the process. The hydrocarbon condensate is further processed as described below.

The electrolyte may be an acid or alkali solution, with selection of either medium being dependent on the contaminants and heteroatoms to be removed. For hydrocarbon heteroatom reactions, an acidic solution has been found to be most effective, with the molarity being calculated on a stoichiometric basis against the mole value sum of the heteroatom species requiring to be reacted.

Where dissolved metals are to be removed from a chemical effluent stream, the electrolyte may be either an acid or alkali solution, depending on the dissolved metal that requires removal from the effluent. The molarity of the electrolyte can be calculated on a stoichiometric basis against the volume percent of dissolved metals within the effluent stream.

Production of persulphate is dependent on a number of factors, (a) the molarity of the electrolyte, (b) the EMF applied through the electrolyte to produce persulphate and (c) the electrical conversion efficiency. From Faradays first law, persulphate is generated in proportion to current density which in this embodiment is dependent upon the surface area of the electrodes in reactor 11 and the amount of time that a given volume of electrolyte is in contact with the electrodes.

For example;

An electrode plate of 1 cm² subjected to 1 amp-hour of current at 90% conversion efficiency (c/e) would generate 3.267 g Persulphate, which would contain 418 grammes of Oxygen which by example and stoichiometric calculation could oxidise approximately 13 g sulphur. However, other heteroatoms within the feedstock will also require a stoichiometric balance with the available Oxygen thus reducing the Oxygen available for Sulphur oxidation. There is therefore a requirement to analyse the feedstock before processing so that the total Oxygen requirement can be calculated and sufficient persulphate produced to allow complete processing of the feedstock.

It follows that a 10 cm² electrode plate subjected to 2 amp-hours of current at 90% c/e would generate 20×3.267 g Persulphate=65.34 g, which at 100 volts dc requires a power input of 0.2 kWh. If the current density is maintained at a fixed rate, then the total power required will be the sum of the current density multiplied by the total surface area of the electrode plates multiplied by the voltage applied to achieve that current density.

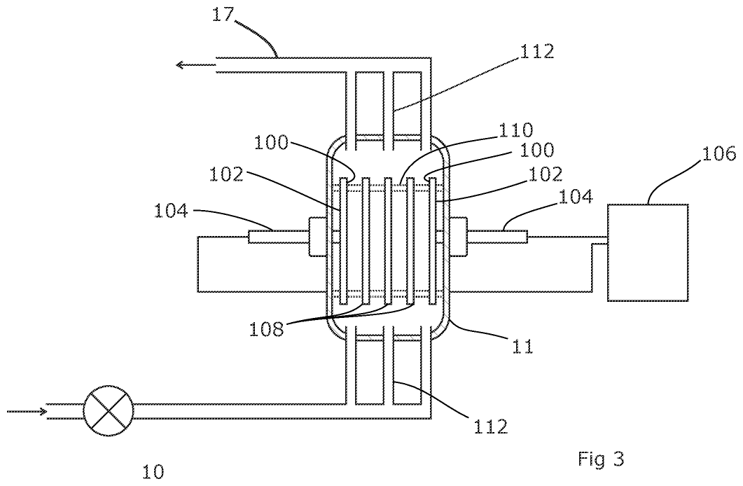

In this embodiment the reactor 11, shown in FIG. 3, contains two flat plate electrodes 100, each with a surface area of sixteen square centimetres. Each electrode plate is mounted onto a 1 mm thick titanium support plate 102 and bonded to its support plate by means of an electrically conductive, chemically resistant epoxy resin. Each titanium plate is mechanically connected to a metal conductor rod 104, so that an external electrical power source 106 connected to the rod is able to pass an electrical current directly to each electrode plate. Additional electrodes 108 are mounted in between the outer electrodes 100 and are of like construction. These are arranged substantially in parallel with the outer electrodes 100 to which power is applied, provide additional surface area, and help define a flow path between the electrodes 100, 108 and parallel to the electrode surfaces. Each electrode assembly is mechanically mounted in a nylon housing 110 (or such other inert material) suitable for the described purpose and is separated from each other electrode plate by a spacer ring of inert material. Any spacer rings can be replaced with rings of alternative thickness so that the gap between the electrodes can be adjusted as necessary to allow a faster or slower electrolyte volume to pass between the electrodes. It has been found that a distance of between 1 mm and 5 mm between adjacent electrodes provides sufficient variation in electrolyte volume and (within the scope of this example) a gap of 3 mm is preferred. The electrode assemblies are mounted within a leak proof reactor chamber 11, arranged parallel with the direction of flow of fluids and gases, with connections 112 provided at each end of the chamber 11 so that fluids and gases may pass entirely through the reactor chamber with as little restriction as possible. In this example, the electrodes require a direct current electrical supply of up to 48 amps at sufficient voltage to overcome the total ohmic resistance in the circuit. A DC voltage of 80 to 100 volts is typically used, which would require a total input power of 4.8 kW theoretically allowing approximately 3.8 tons of hydrocarbon having a 1% Sulphur content to be processed per hour.

The total power requirement can usually be supplied by a commercial DC power supply, ideally having independent voltage and current controls. Additional electrode plates could be provided to increase the available electrode surface area and would require a directly corresponding increase in the DC power supply to process higher volumes of hydrocarbon bearing materials. It will also be evident that alternative electrodes, mechanical fixings and adjustment arrangements are possible without changing the intent of the embodiment.

The material selected for the electrode plates should provide good electrical conductivity, low ohmic resistance and resistance to oxidation and acids. Carbon/graphite fibre mat, platinum, titanium and boron doped diamond all meet the necessary mechanical requirements as electrodes and are also able to withstand the required current densities without breakdown of electrical continuity. We have found from tests carried out that in the conditions described within this embodiment, boron doped diamond provides the preferred stable performance characteristics.

It might reasonably be assumed that the strongest possible electrical field would be desirable to effect a rapid reaction, but an increase in total electrical input power will cause heat to be generated within the electrodes. Thus a sufficient volume of electrolyte needs to pass over each electrode to ensure that excess heat does not build up to the point where electrode damage might occur. Calculations can be performed locally for each application and the direct current electrical supply applied to the electrodes adjusted to ensure that (i) the current density is sufficient to cause the required persulphate reaction, (ii) heat generated by the electrodes is effectively dissipated by sufficient passing volume of electrolyte and (iii) the molar value of the electrolyte is sufficient to allow the persulphate reaction to proceed efficiently.

There will generally be a considerable variation in the amount of sulphur and other heteroatoms within the materials that the present invention is able to process. It is therefore a key aspect of this embodiment that there should be an ability to rapidly vary the current density to increase or decrease the oxidation capability of the process to match higher or lower concentrations of heteroatoms as they arise. If low concentrations are contained within a feedstock, it would be appropriate to operate the process at less than maximum current density to potentially avoid oxidising useful hydrocarbons. In the example within this embodiment, the maximum current density is required to be more than two amps and less than three amps per square centimetre of electrode surface area, at the lowest voltage that will overcome electrical resistance within the process whilst still maintaining the desired current density. Multiple electrode plates will naturally provide a greater surface contact area to allow for reactions to proceed, but will require proportionately larger power supplies to match the area increase.

To provide efficiency of operation, the process of the present invention has been designed as a two-stage process whereby the first stage of oxidation reaction is at the point of contact between the electrolyte and hot gases and the second oxidation reaction occurs where the hydrocarbon condensate/electrolyte mixture passes through the reactor chamber. It is possible to add further reactors in parallel to provide additional stages of oxidation reaction, but (depending on the materials selected for the electrodes) this may incur disproportionate cost increases which could be significantly detrimental to the commercial performance of the process.

Electrosynthesis of aqueous chemical solutions does also cause electrolysis which produces oxygen (O₂) and hydrogen gas (H) from anode and cathode electrodes and the gases are produced directly in proportion to the emf at the electrodes. It will be seen that high potential emfs can be utilised in the embodiment described herein which can cause substantial volumes of O₂ and H gases to be generated within the electrosynthesis chamber. A proportion of these gases are captured within the reaction/electrolysis chamber and directed to recirculate with the electrolyte which potentially allows additional electron reactions to take place as part of the chain reaction described previously. Unreacted gases return through the process flow system and again potentially add to the electron reactions taking place within the generated electrical field. Unrecirculated gases are collected via the vacuum system and directed to a thermal oxidiser or process combustion device where they may undergo controlled combustion to create steam for steam turbine power generation or for ongoing process heat.

The mixed hydrocarbon condensate, electrolyte and gas stream emerging from the reactor 11 passes to a separation vessel 18 where the hydrocarbon condensate and aqueous streams are separated by centrifugal action or such other commercial device that separates liquid streams of differing specific gravity. Typically, a centrifuge, hydrocyclone or porous ceramic tube or membrane separation processes (with or without vacuum assistance) are commercially proven processes. The separated electrolyte is pumped from the separation chamber to an ion exchange unit 19 or other device previously described, where oxidised heteroatoms are removed and the clean electrolyte passes to a cooling device 20 where the output temperature is automatically maintained to a temperature of between 5-25 degrees Celsius. The cool electrolyte then passes to a storage tank 21 from where it is pumped (22) to the reactor assemblies to be reacted with the hot gas as described above and the top of column 9. The buffer tank 21 is provided with a pH sensor and airlock device so that the molarity and volume of the electrolyte can be maintained as required. Commercial test kits are available to test Persulphate concentration and, where necessary, a further Persulphate reactor may be provided in circuit with the buffer tank to maintain and adjust the required Persulphate concentration.

The separated hydrocarbon condensate is pumped via valve 23 through a vacuum relief device to a solvent extraction column 24 where it is mixed with a solvent to extract any oxidised metals or heteroatoms that have not dissolved into the electrolyte.

Mineral and synthetic oils may absorb metals during normal lifetime use and where oil products are subject to mechanical use and heat, metal ions act as catalysts to oxidise the oil. Oxidation compounds (including dissolved metals) must therefore be removed from the hydrocarbon condensate before it can achieve a recognised fuel or oil specification. Oxidative compounds are naturally polar and are extracted from the hydrocarbon condensate by first vigorously mixing the hydrocarbon condensate with a polar solvent. This mixing action will attract the polar contaminants out of the hydrocarbon condensate and into the solvent. The method of mixing the oil and solvent will depend on the volume of materials being processed. In a small process installation, a continuous mechanical mixing device may be appropriate, whereas larger oil volumes may require a counter current packed column or other constant flow mechanism that allows intimate contact between the solvent and the oil.

Several polar solvents are capable of being used to achieve this objective. Examples that have been successfully tested are acetone, acetonitrile, dimethyl formamide and methanol. Solvents may be used in a preferred ratio of one-part solvent to one-part hydrocarbon condensate (1:1), although higher and lower ratios may be appropriate depending on the level of contamination removed by the first and second stage electrolyte oxidation process.

After mixing, the solvent and hydrocarbon condensate are separated in a commercial separation process such as a centrifuge 25a, 25b. The solvent passes via pipes 26a, 26b to a commercial recovery process such as a vacuum distillation process (illustrated) comprising a solvent boiling vessel 28, a pump 29 delivering the evaporated solvent to a condenser 30, and a storage vessel 32 to hold the recovered solvent before it is reintroduced into the solvent mixing column 24. A vacuum relief device/valve 31 allows the vacuum on the delivery side of the solvent recovery unit to be released so that the solvent reservoir 32 can be at atmospheric pressure.

The contaminants that were dissolved into the solvent have a boiling point significantly above the boiling point of the solvent, and therefore said contaminants will not pass through the solvent recovery process. This will result in a small volume of contaminant compounds and a viscous hydrocarbon residue remaining within the solvent boiling vessel 28; these residues may be collected in storage vessel 34 and disposed of by controlled combustion for heat recovery 35. Following this separation process, the hydrocarbon distillate is free of contamination and is pumped to a storage vessel 27 prior to use as a recycled feedstock for use in industrial manufacture of new polymers or as a clean distillate fuel.

Thus, the present invention provides an effective method of receiving mixed thermoplastic packaging, halogenated plastics and oils, end of life rubber tyres, waste oils and fuels etc. which could otherwise cause massive ground, water and atmospheric emissions by incineration or landfill.

Thus by separating, recovering and processing waste hydrocarbons to remove heteroatoms and contaminants, clean new products are created which have an industrial demand, support the circular economy and prevents new CO2e gas being created in the manufacture of virgin products.

It will of course be understood that many variations may be made to the above-described embodiment without departing from the scope of the present invention.

1. A method of treating a mixed-material feedstock comprising:
a) subjecting the feedstock to a first process profile comprising at least one of an elevated temperature, a reduced pressure and/or a controlled speed of travel through the process, thereby to release a gas phase;
b) contacting the gas with an aqueous electrolyte;
c) condensing the gas phase to a liquid or a liquid/gas mixture, and removing its aqueous component;
d) passing a substantial part of the remainder of the feedstock to a subsequent process profile comprising at least one of an temperature and vacuum pressure which is elevated relative to the previous process profile and/or a controlled speed of travel through the process, thereby to release a further gas phase;
e) contacting the further gas phase with an aqueous electrolyte; and
f) condensing the further gas phase to a liquid or a liquid/gas mixture, and removing its aqueous component; and
optionally, repeating steps d) to f).

2. The method according to claim 1, wherein heteroatoms in the hydrocarbon are oxidised by reaction with the electrolyte.

3. The method according to claim 1, wherein the liquid contains aqueous and hydrocarbon phases, which are separated thereby to remove the aqueous component and to recover the hydrocarbon condensate having a substantially reduced or removed heteroatom content.

4. The method according to claim 3 in which the aqueous and hydrocarbon phases are separated by a mechanical means.

5. The method according to claim 1, in which the aqueous persulphate electrolyte is held in a reservoir prior to being contacted with the gas phase hydrocarbon.

6. The method according to claim 5 in which the aqueous persulphate electrolyte in the reservoir is maintained at a temperature of 5 to 25 degrees Celsius.

7. The method according to claim 1, in which the hydrocarbon feedstock is supplied in a continuous stream.

8. The method according to claim 1, in which the hydrocarbon is heated in an environment at lower than atmospheric pressure.

9. The method according to claim 1 in which, after separation of the aqueous component, the hydrocarbon residue is mixed with a polar solvent and then passed to a solvent recovery process.

10. The method according to claim 9 in which the solvent recovery process includes a vacuum distillation step.

11. The method according to claim 1, in which after the condensation step, the reaction product is subjected to an electrical field generated by at least two opposing electrode plates between which the reaction product flows.

12. A method of treating liquid hydrocarbons, comprising reacting the hydrocarbon with a persulphate thereby to oxidise heteroatoms in the hydrocarbon, and subjecting the reaction product to an electrical field generated by at least two opposing electrode plates between which the reaction product flows.

13. The method according to claim 11 in which the electrode plates are substantially parallel.

14. The method according to claim 11 in which the electrode plates are spaced apart by a distance between each electrode surface of between 1 and 5 millimetres.

15. The method according to claim 11 in which the electrical current density between the plates is between 2 and 3 amps per square centimetre of electrode surface area.

16. The method according to claim 11 in which the voltage applied across the electrode plates is in the range of 10-100 volts according to the conductivity of the electrolyte.

17. The method according to claim 11 in which an aqueous phase is subsequently separated from the reaction product.

18. The method according to claim 17 in which the aqueous phase is passed through an ion exchange device to remove oxidised heteroatoms therein, to yield a substantially heteroatom free persulphate electrolyte.

19. The method according to claim 18 in which the persulphate electrolyte is recirculated within the process.

20. The method according to claim 1, conducted at a pressure below atmospheric pressure.

21. The method according to claim 20, conducted at a pressure of less than 14000 Pa.

22. The method according to claim 1, wherein the hydrocarbon being treated is derived from the pyrolysis of a material having a hydrocarbon content.

23. The method according to claim 22 in which the material is a mix of materials comprising mixed thermoplastic and thermosetting materials, paper, card, metals and plastic film, chemically and/or mechanically bonded to form a unitary material, used rubber and used oils, pyrolysed to yield (i) a hydrocarbon liquid for treatment (ii) a solid fuel and (iii) recovered separated metals and other non-hydrocarbon materials.

24. The method according to claim 22 in which the material is a mix comprising used rubber, used oils and a plastics material, pyrolysed to yield (i) a hydrocarbon liquid for treatment and (ii) a solid fuel.
